(19) United States
(12) Patent Application Publication
(10) Pub. No.: US 2010/0117282 A1
(43) Pub. Date: May 13, 2010

(54) VISE FOR A DIRECTIONAL DRILLING MACHINE

(75) Inventor: Peter C. Rozendaal, Pella, IA (US)

Correspondence Address: MERCHANT & GOULD PC, P.O. BOX 2903, MINNEAPOLIS, MN, 55402-0903, US

(73) Assignee: Vermeer Manufacturing Company, Pella, IA (US)

(21) Appl. No.: 12/523,815

(22) PCT Filed: Jan. 17, 2008
(86) PCT No.: PCT/US08/51279

§ 371 Date: Jan. 15, 2010

Related U.S. Application Data
(60) Provisional application No. 60/885,823, filed on Jan. 19, 2007.

(51) Int. Cl. B25B 1/04; B25B 1/24

(52) U.S. Cl. 269/111; 269/257

(57) ABSTRACT

A vise apparatus includes a vise die assembly that is pivotally mounted to tong heads of a vise mechanism. The vise die assembly includes a plurality of vise die and a mounting block having a first face and an oppositely disposed second face. Each of the plurality of vise die includes a gripping surface. A first vise die of the plurality of vise die is mounted to the first face of the mounting block while a second vise die is mounted to the second face. The first and second vise die are mounted such that the gripping surface of first vise die faces opposite the gripping surface of the second vise die.

This application is being filed on 17 Jan. 2008, as a PCT International Patent application in the name of Vermeer Manufacturing Company, a U.S. national corporation, applicant for the designation of all countries except the US, and Peter C. Rozendaal, a citizen of the U.S., applicant for the designation of the US only, and claims priority to U.S. Provisional Patent Application Ser. No. 60/885,823, filed Jan. 19, 2007. Such provisional application is incorporated herein by reference.

### FIELD OF TECHNOLOGY

The present invention relates generally to horizontal underground drilling machines. More particularly, the present invention relates to a vise apparatus used with threaded drill pipe.

### BACKGROUND OF THE INVENTION

A variety of vise arrangements for use with horizontal drilling machines exist, including vise jaws having two opposing jaw halves. The jaws are arranged to clamp onto a pipe to either thread or unthread the pipe to another pipe. The vise jaws are clamped to the pipe by hydraulic actuators or cylinders that provide engagement or clamping force.

In conventional jaw designs, the maximum torque applied to the gripped pipe, without relative movement between the pipe and the jaws, is directly proportional to the force applied by hydraulic cylinders. The torque effected on the pipe provides torque holding capacity at a threaded connection between the two pipes. Larger pipes require greater torque to effect sufficient torque holding capacity. The drill pipe used in conjunction with the conventional jaw design is limited, typically ranging from 1½ to 3½ inches in outer diameter.

Drilling machines utilizing much larger drill pipe and drill tools are becoming available for use in the industry. For example, some drill pipe can range up to about 8 inches in outer diameter. A design that provides greater engagement force to effect sufficient torque holding capacity at a threaded connection between larger pipes is needed.

Conventional designs incorporating a latch door arrangement for use on vertical drilling machines have been used to provide sufficient engagement force on larger diameter pipes. These designs, however, are particular to vertical drilling rigs wherein there is ample space in the vicinity of the latch door vise arrangement. A vise apparatus that accommodates large pipe is needed for use on a horizontal drilling machine where space between the ground and a ground support is limited.

### SUMMARY OF THE INVENTION

The disclosure describes a vise apparatus for use on a horizontal drilling machine. The vise apparatus includes a vise die assembly that is pivotally mounted to tong heads of a vise mechanism. The vise die assembly includes a mounting block having a front face and a second face that are oppositely disposed on the mounting block. A vise die having a gripping surface is mounted to each of the first face and the second face of the vise die assembly.

### BRIEF DESCRIPTION OF THE DRAWINGS

The accompanying drawings are included to provide a further understanding of the present invention and are incorporated in and constitute part of this specification. The drawings illustrate exemplary embodiments of the present invention and together with the description serve to further explain the principles of the invention, wherein:

FIG. 1 is a front perspective view of a rack assembly for use on a horizontal directional drilling machine in accordance with the principles of this disclosure;

FIG. 2 is a side view of the rack assembly of FIG. 1;

FIG. 3 is a front view of a vise assembly as shown in FIG. 1;

FIG. 4 is a front perspective view of a vise die assembly; and

FIG. 5 is a enlarged fragmentary front view of the vise assembly of FIG. 3.

### DETAILED DESCRIPTION OF THE PREFERRED EMBODIMENT

With reference now to the various figures in which identical elements are numbered identically throughout, a description of various exemplary aspects of the present invention will now be provided.

### I. General Operation of the Vise Apparatus in Horizontal Drilling

The present invention is directed to a vise apparatus for use on horizontal drilling machines. Horizontal drilling machines typically comprise a rotational drive mechanism, a longitudinal drive mechanism, a vise apparatus, a ground support, and a drill pipe storage/transfer apparatus. The drilling process involves threading together lengths of threaded drill pipe to form a drill string extending from the drilling machine though a bored hole and terminating at a drill bit assembly. The drill string transfers rotational torque and longitudinal thrust from the drive mechanisms to the drill bit assembly.

To begin drilling a bore, the drill bit assembly is located near the ground support of the horizontal drilling machine and is attached to a drill string. The drill string initially comprises a first drill pipe that is attached to the rotational drive mechanism and longitudinal drive mechanism. The rotational drive mechanism and longitudinal drive mechanism are typically located at an end opposite the bore location. The first step of boring is thus to attach the drill bit assembly to the first drill pipe.

The drill bit assembly is generally larger in diameter than the drill pipe. Conventional designs require that the drill bit assembly be connected to the first drill pipe by manual wrenching. It would be beneficial to connect the drill bit assembly to the first drill pipe by inserting the drill bit assembly into a vise apparatus to aid in the preparations of drilling the bore. The vise apparatus according to the principles of this disclosure provide such utility in an open dimension or adaptable configuration that permits drill bit assemblies to be inserted and clamped into the vise apparatus, as will be described later in detail.

Once the drill bit assembly is connected to the first drill pipe, the drill string (the drill bit assembly and the first drill pipe) are rotated and propelled into the ground. As the drill string progresses, a second drill pipe is removed from the storage/transfer apparatus and positioned in alignment with the drill string. Typically the storage/transfer apparatus comprises a magazine wherein the longitudinal axis of the stored drill pipe is parallel to the drill string. Once positioned, the second drill pipe is threaded to the drill string. The process is repeated to extend the length of the bored hole.

The drill string is subjected to high torque loads. In directionally controlled applications, the drill string is also subjected to significant bending loads. Proper mating of threaded joints between the drill pipes is critical to the performance of the drill string. To properly “make-up” the threaded joints, significant torque loads must be applied to the outer diameters of the drill pipes.

When the bored hole is as long as desired, the drill bit assembly is often changed; or, for a variety of reasons, the drill string is removed from the bored hole. In the latter case, for example, the fixed lengths of drill pipes are subsequently pulled out of the bored hole, unthreaded, and transferred back to storage. Removal of the drill string involves “break-out” of the threaded connections or joints. The break-out torque necessary to break the threaded connection is generally similar or greater than the torque required to initially make-up the threaded joint.

Vise configurations of conventional designs involve a lower clamp, an upper clamp, and a driver. The driver is a part of the drilling machine that is longitudinally propelled, typically along a track, and has a male threaded end, or pin end. In make-up operations, the driver advances the drill string along a longitudinal axis until the driver reaches an end of the track. At that point, the lower clamp secures the drill string in a stationary position. The driver rotationally reverses to unthread from a box end (or female threaded area) of the drill string while reversing longitudinally along the track. A new drill pipe is positioned within a loading area either manually or with a rod loader mechanism. The driver changes rotational direction and begins to again longitudinally advance along the track toward the new drill pipe. The pin end of the driver engages a box end (i.e. female threaded-end) of the new drill pipe. As the driver continues to advance longitudinally, a pin end of the new drill pipe engages the box end of the clamped drill string and repeats the process.

As a wider variety of tools used in horizontal drilling become available, the need to adapt the vise apparatus to accommodate the various shapes and sizes of tools becomes more important. For instance, some applications insert a relatively short pipe section having the same diameter as the final bored hole into a section of the bored hole to stabilize the soil. This pipe section is commonly known as a slip lining. Because the slip lining has a diameter larger than the diameter of the drill string, the slip lining is typically difficult or impossible to fit within the vise apparatus of conventional designs.

Another consideration with regards horizontal drilling concerns the overall arrangement of the drilling machine and vise apparatus in relation to ground. Placement of the drilling machine such that the vise apparatus is as close to the entrance of the bored hole as possible is important to provide maximum support of the drill string. Thus, the opening diameter and the overall envelope of the vise apparatus must ideally accommodate installation of slip lining having a large diameter, yet must be sized for placement that provides drill string support. The vise apparatus according to the principles of this disclosure provides such a feature wherein the design minimizes the cross-sectional size of the overall apparatus assembly while maximizing the opening diameter, as will be described later in detail.

In general, the horizontal drilling machine as described by this disclosure comprises of a main chassis assembly having a ground engaging device, tracks, an engine and hydraulic drive unit, an operator's station, and a main frame. The main chassis assembly of the horizontal drilling machine generally comprises a rack assembly having some type of rod loading and handling device, or pipe magazine. Theses devices ranges from basic transfer mechanisms such as various types of hoists or slings to highly specialized mechanized units specifically designed to manipulate specific rods.

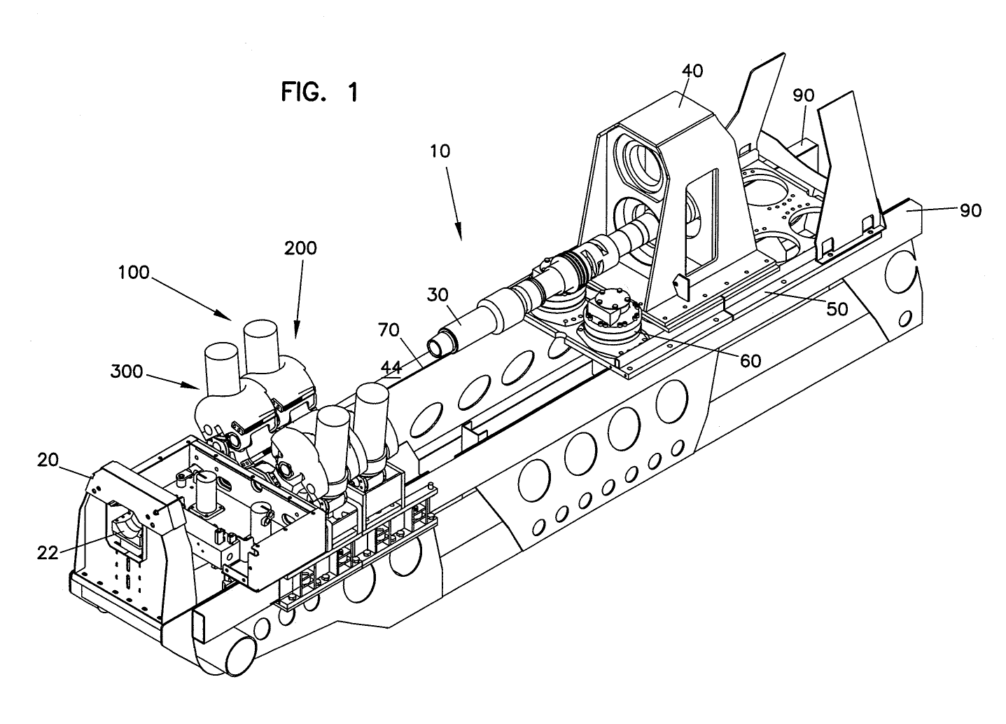

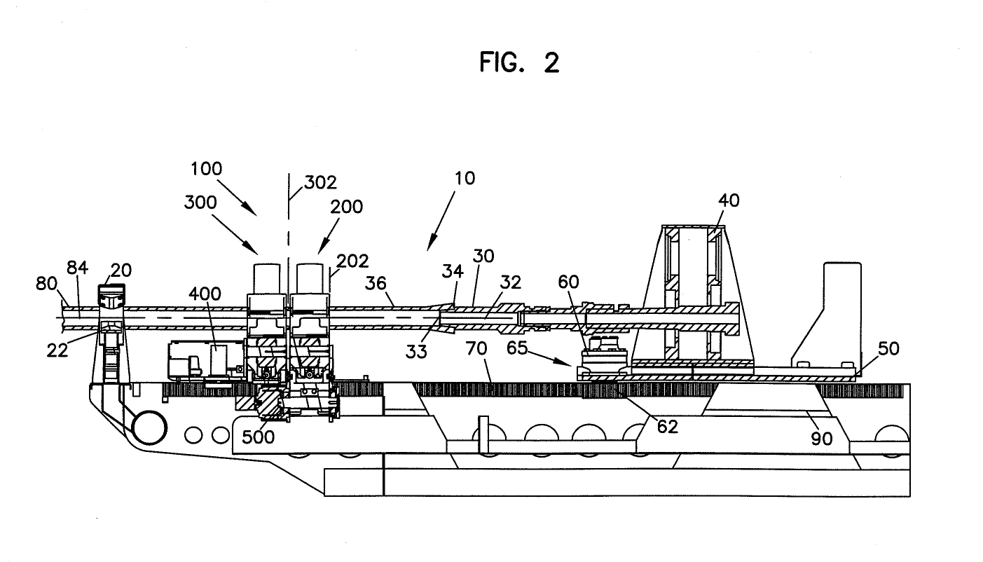

Referring to FIGS. 1 and 2, a rack assembly 10, (shown without a pipe magazine) is illustrated. The rack assembly 10 is mounted to a chassis assembly (not shown) of a horizontal drilling machine. The rack assembly 10 comprises a vise apparatus 100. The vise apparatus 100 according to the principles disclosed could be applied to a variety of machines that utilize clamping devices.

FIG. 2 is a side view of the rack assembly 10 and illustrates components that manipulate a drill rod, tube or pipe 36. The rack assembly 10 includes a front centering assembly 20, the vise apparatus 100, and a spindle 30 coupled to a rotational gearbox 40. The rotational gearbox 40 is mounted to a thrust frame 50 onto which thrust motors 60 are mounted. The trust motors 60 rotationally drive pinion gears 62 that engage rack gears 70. The resulting rack and pinion gear drive 65 propels the thrust frame 50 forward and backward along rack rails 90 of the rack assembly 10. The thrust frame 50 therein propels the spindle 30 and the drill string 80 longitudinally, while at the same time the rotational gearbox 40 rotates the drill string 80. In the alternative, the rack and pinion gear drive 65 may be replaced by cylinder and chain mechanisms or straight cylinder mechanisms to provide longitudinal force to the drill string 80.

The vise apparatus 100 further includes a rotating vise assembly 200, a fixed vise assembly 300, a longitudinal positioner 400, and a rotational vise driver 500. These components function to operate drilling processes such as, for example, starting and extending the drill string, known as performing the pilot bore process, and retracting the drill string, known as pull-back.

### II. Operation of the Vise Apparatus: Starting and Extending the Drill String

In general, when starting a drilling operation, the drill string will initially consist of only one drill pipe and a drill head assembly. The drill head assembly typically comprises a variety of components such as a drill bit and a sonde housing to hold a radio transmitting device that locates and controls the drill head assembly during the drilling process.

Referring again to FIG. 1, the drill head assembly (not shown) may be supported by the front centering assembly 20 and the fixed vise assembly 300, or it may be positioned just beyond the front centering assembly 20. The front centering assembly 20 includes a drill pipe centering support 22 that may be adjusted vertically to align a centerline 84 of a drill string 80 with an axis 32 of the spindle 30 (shown in FIG. 2).

A single drill pipe (not shown) moves from a drill pipe storage location into a drill pipe load area 44. In the drill pipe load area 44, the drill pipe is positioned in an axial orientation defined by the longitudinal axis of the spindle 30. The load area 44 lies generally between a rear plane 202 of the rotating vise assembly 200 and a first end 33 of the spindle 30. The load area 44 is effectively open when the thrust frame 50 has been moved back along the rack rails 90 such that the rotational gearbox 40 and spindle 30 are fully retracted. In this loading position, the distance between the rear vise plane 202 and the first end 33 of the spindle 30 is greater than the length of the drill pipe (not shown).

With the thrust frame 50 in the loading position, the first drill pipe is positioned in the drill pipe load area 44 and held by the drill pipe transfer mechanism (not shown). The rotational gearbox 40 rotates the spindle 30 while the spindle 30 is propelled longitudinally by the thrust frame 50. As the spindle 30 propels forward, a threaded male end or pin end 34 of the spindle 30 engages female threads of the drill pipe (not shown).

If the fixed vise assembly 300 supports the drill head assembly, the drill pipe and the spindle 30 are propelled longitudinally until a threaded front end of this first drill pipe is inserted into the drill head assembly. The rotational gearbox 40 continues to rotate the first drill pipe to thread the first drill pipe to the drill head assembly. The fixed vise assembly 300 holds the drill head assembly stationary while the rotational gearbox 40 controls the level of torque applied to properly make-up the threaded joint between the drill head assembly and the first drill pipe. The same level of torque is, at the same time, applied between the first drill pipe and the spindle 30.

If the drill head assembly is out front of the front centering assembly 20, the first drill pipe is propelled forward until a front portion extends into the fixed vise assembly 300. The fixed vise assembly 300 grips the first drill pipe and prevents the first drill pipe from rotating so that proper torque is applied to the joint between the first drill pipe and the spindle 30. Once the joint is properly torqued, the fixed vise assembly 300 releases the first drill pipe and the first drill pipe is propelled through the front centering assembly 20 where the drill head assembly can be installed. The drill head assembly in this case is typically torqued with some form of hand held wrench.

After installing the drill head assembly to the first drill pipe (now referred to as a drill string), the pilot bore process is performed by longitudinally propelling the drill string forward until the joint between the spindle and the drill pipe is located near a middle location 302 between the fixed vise assembly 300 and the rotating vise assembly 200. The fixed vise assembly 300 securely clamps the drill string and the spindle 30 is rotated in a reverse direction while being propelled backward along the rack rails 90 so that another drill pipe can be positioning in the drill pipe load area 44. The process of propelling the rotating spindle forward and applying proper torque between the joints of the drill pipes is repeated to effectively extend the drill string. The drill string is extended until the underground drill path reaches a desired distance. Thus the main function of the fixed vise assembly 300 of the vise apparatus 100 in performing the pilot bore process is to hold the drill string in a stationary position while a new drill pipe is positioned and threaded into the drill string.

### III. Operation of the Vise Apparatus: Retracting the Drill String

The pull-back process involves pulling the drill string back through the pilot bore. The thrust frame 50 is reversed in the longitudinal direction to pull the drill string back until a first joint between the last added drill pipe and the remainder of the drill string is located at the middle location 302. At this position, the fixed vise assembly 300 clamps the drill string. The rotating vise assembly 200 rotates clockwise in an opened, unclamped position, clamps the last added drill pipe at a first location, and rotates counterclockwise to break the joint between the last added drill pipe and the drill string. The rotating vise assembly 200 then opens to release the last added drill pipe. The rotational gearbox 40 reverse rotates while the thrust frame moves back to separate the last added drill pipe from the drill string. Once the last added drill pipe is separated from the drill string the rotating vise assembly 200 clamps the last added drill pipe at a second location. The spindle 30 reverse rotates to break a second joint between the spindle 30 and the last added drill pipe. Once that joint is broken and the last added drill pipe is separated from the spindle 30, the rotating vise assembly 200 opens and the drill pipe is removed. To continue the process, the spindle 30 translates forward to mate with the drill string still clamped by the fixed vise assembly 300. The spindle is threaded to the drill string with the proper torque. The fixed vise assembly 300 opens and the drill string is pulled backwards to repeat the break-out procedure.

Thus, the functions of the vise apparatus 100 in the pull-back process include breaking the first joint between the drill string and the last added drill pipe, holding the drill pipe while the second joint between the drill pipe and spindle is broken, and holding the drill string while the spindle is re-attached to repeat the break-out procedure.

As the vise apparatus 100 has been described in detail in U.S. Pat. No. 6,880,430, assigned to the assignee of the present invention and incorporated herein by reference, further description of the vise apparatus 100 will not be provided herein.

### IV. Structural Description of the Vise Assembly

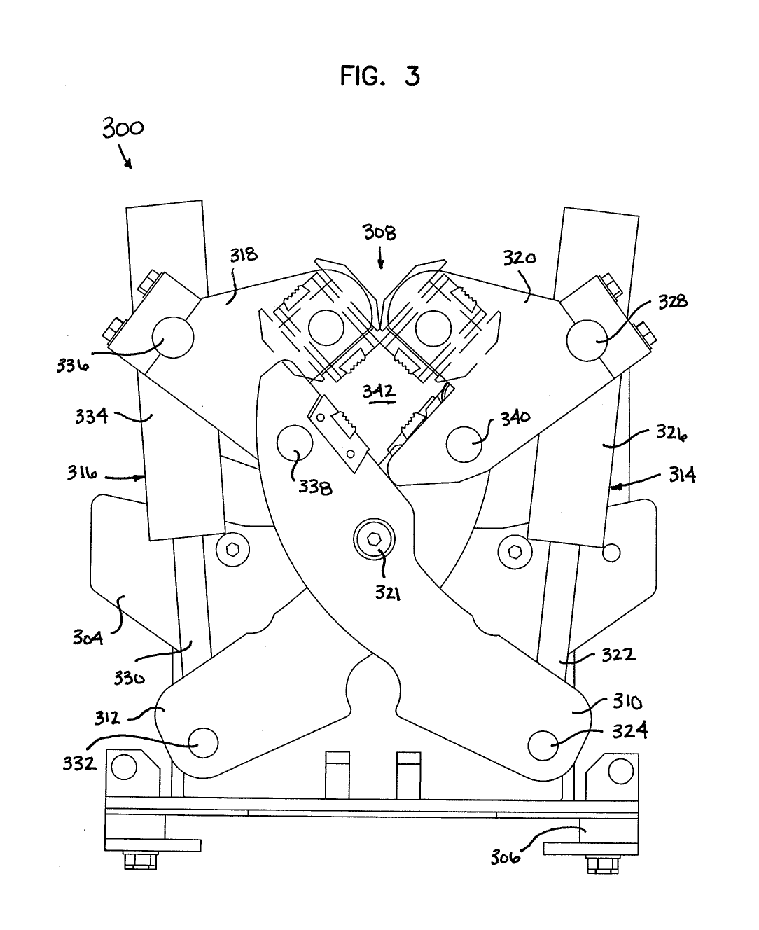

Referring now to FIG. 3, the fixed vise assembly 300 will be described. Since similar structural elements associated with the present invention are found in both the rotating vise assembly 200 and the fixed vise assembly 300 of the vise apparatus 100, the following description will be made with reference to the fixed vise assembly 300 only.

The fixed vise assembly 300 includes a base frame 304, having a plurality of mounts 306 for mounting the fixed vise assembly 300 to the rack assembly 10. The fixed vise assembly 300 further includes a fixed vise mechanism, generally designated 308. The fixed vise mechanism 308 includes first and second arm members 310, 312, first and second actuators 314, 316, which effectuate the opening and closing of the first and second arm members 310, 312, and first and second tong heads 318, 320. While the first and second actuators 314, 316 have been shown in the figures as being hydraulic cylinders, it will be understood by those skilled in the art after reviewing the present disclosure that the scope of the present invention is not limited to the use of hydraulic cylinders since various actuators could be used in association with the present invention.

The first arm member 310 is pivotally connected to the second arm member 312 and the base frame 304 at pivot 321. The pivot 321 provides for a scissor type motion between the first arm member 310 and the second arm member 312. However, while the arm members 310, 312 have been shown in FIG. 3 as being “scissor” members with a pivotal connection, it will be understood by those skilled in the art after reviewing the present disclosure that the scope of the present invention is not limited to the arm members being pivotally connected.

The first actuator 314 includes a rod end 322, which is pivotally connected to the first arm member 310 at rod pivot 324, and a cylinder end 326, which is pivotally connected to the second tong head 320 at cylinder pivot 328. The second actuator 316 includes a rod end 330, which is pivotally connected to the second arm member 312 at rod pivot 332, and a cylinder end 334, which is pivotally connected to the first tong head 318 at cylinder pivot 336.

The first arm member 310 is pivotally connected to the first tong head 318 at tong head pivot 338, while the second arm member 312 is pivotally connected to the second tong head 320 at tong head pivot 340. These pivotal connections (i.e. pivot 321, rod pivots 324, 332, cylinder pivots 328, 336, and tong head pivots 338, 340) and the first and second actuators 314, 316 effectuate the actuation of the vise mechanism 308. For example, when the rod ends 322, 330 of the first and second actuators 314, 316 are extended from the cylinder ends 326, 334, the first and second tong heads 318, 320 of the vise mechanism 308 approach each other (“close”) defining an opening or pocket 342. In accord with the principles of this disclosure, the pocket 342 of the vise mechanism 308 is adapted to accommodate a variety of sized drill pipe or drill bit assemblies. When the rod ends 322, 330 of the first and second actuators 314, 316 are retracted toward the cylinder ends 326, 334, the first and second tong heads 318, 320 of the vise mechanism 308 separate from each other, thereby opening the pocket 342.

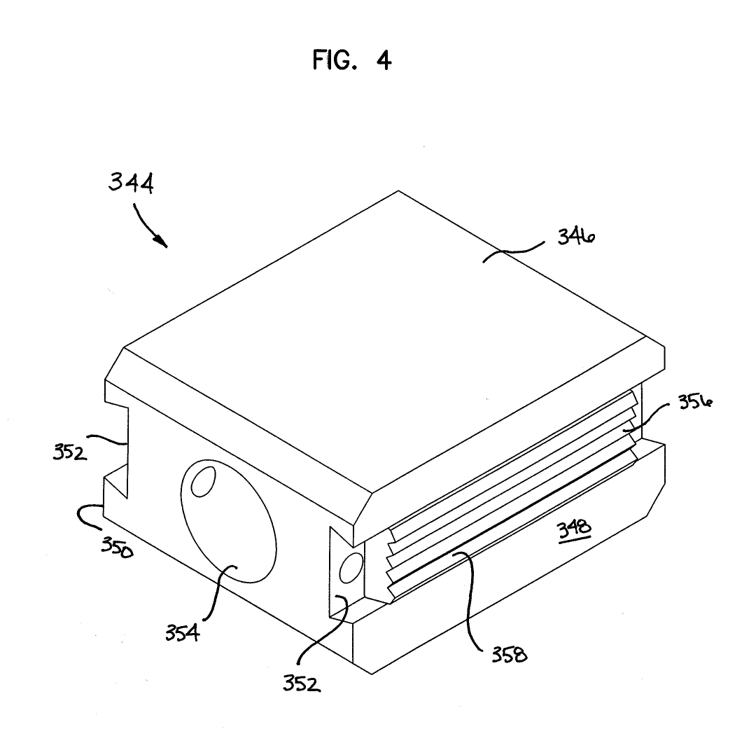

Referring now to FIG. 4, a vise die assembly 344 will now be described. The vise die assembly 344 includes a mounting block 346 having a first face 348 and a second face 350, with the second face 350 being about parallel to the first face 348. A groove or slot 352 is defined within each of the first and second faces 348, 350. In the preferred embodiment, the groove 352 extends the length of the faces 348, 350 and is adapted to be of a dovetail configuration. However, it will be understood by those skilled in the art after reviewing the present disclosure that the scope of the present invention is not limited to the groove 352 extending the length of the faces 348, 350 or having a dovetail configuration. The mounting block 346 further defines a pivot hole 354 that extends through the length of the mounting block 346 in a direction parallel to the first and second faces 348, 350. It will be understood, however, by those skilled in the art that the scope of the present invention is not limited to the pivot hole extending through the length of the mounting block 346. A vise die, gripping member, or jaw 356, having a gripping surface 358 is disposed within the groove 352 of the first face 348 and the groove 352 of the second face 350 of the mounting block 346. The jaws 356 are arranged in the grooves 352 such that the gripping surface 358 of the jaw 356 in the first face 348 faces oppositely the gripping surface 358 of the jaw 356 in the second face 350. As the gripping surface 358 of jaws 356 are used to contact a drill pipe or drill bit, the jaws 356 are made of steel that is hardened to a desired hardness in order to reduce the wear of the gripping surface.

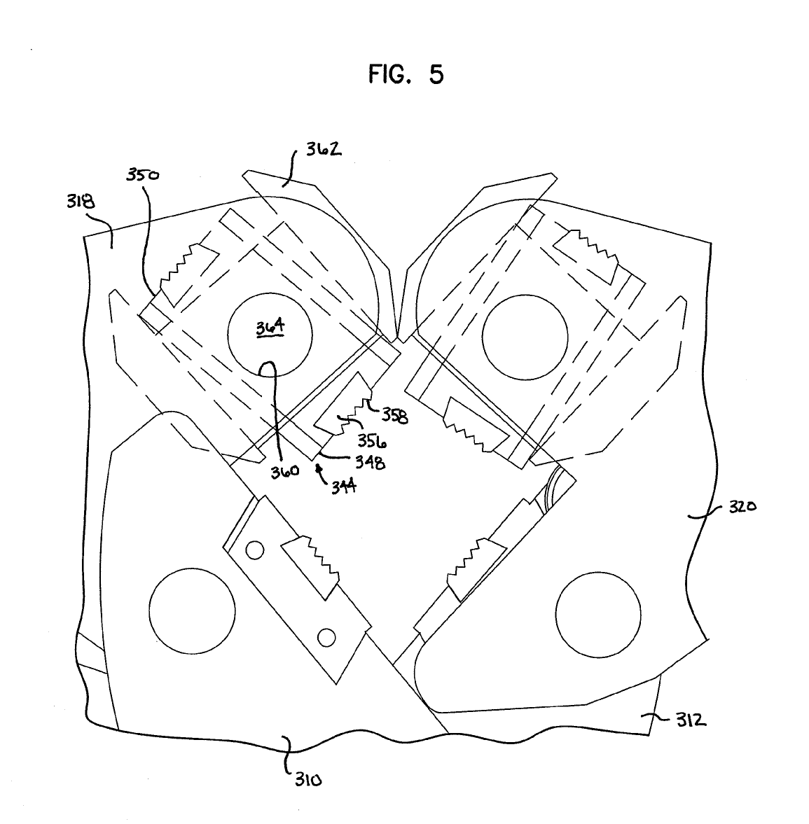

Referring now to FIG. 5, at least one vise die assembly 344 is located on each of the tong heads 318, 320. Since each tong head 318, 320 includes a vise die assembly 344, the following description will be made with reference to the first tong head 318 only. It will be understood, however, that this description is also applicable to the vise die assembly 344 associated with the second tong head 320. The first tong head 318 includes a pivot hole 360 and at least one pivot stop 362. In the preferred embodiment, however, there are two pivot stops 362 per tong head 318, 320. The vise die assembly 344 is pivotally mounted to the first tong head 318 by a pivot pin 364 that extends through the pivot hole 360 in the first tong head 318 and the pivot hole 354 in the mounting block 346. In the depicted embodiment, the vise die assembly 344 is mounted between the pair of pivot stops 362 such that the pivot stops 362 cooperate to limit the range of clockwise and counterclockwise pivotal motion of the vise die assembly 344 with respect to the first tong head 318. The vise die assembly 344 is pivotally mounted to the first tong head 318 such that one of the gripping surfaces 358 of the jaws 356 is facing toward the pocket 342 when the vise mechanism is in the closed position. The pivotal mounting of the vise die assembly 344 allows for better alignment between the gripping surfaces 358 and the drill pipe in the pocket 342. Proper alignment between the gripping surfaces 358 and the drill pipe is important in order to ensure a more consistent coefficient of friction between the gripping surfaces 358 and the drill pipe.

Over time and frequent use, the coefficient of friction between the gripping surfaces 358 and the drill pipe may decrease. This reduction in the coefficient of friction is caused by wear to the gripping surfaces 358. As the coefficient of friction between the gripping surfaces 358 and the drill pipe deceases, the drill pipe will begin to “slip” in the vise mechanism 308. If this slippage occurs, it is usually necessary to replace the vise die, which could create a commercial loss due to machine downtime if another vise die is not readily available. The vise die assembly 344 in the present invention, however, has two gripping surfaces 358 per vise die assembly 344. Therefore, if the drill pipe in the vise mechanism begins to slip due to wear of the gripping surface 358 of the jaw 356 of the first face 348, the vise die assembly 344 can be disassembled from the tong head 318, 320 [e.g. by removing the pivot pin 364] and inverted and reassembled such that the gripping surface 358 of the jaw 356 of the second face 348 is now facing the pocket 342 when the vise mechanism 308 is in the closed position. By incorporating two gripping surfaces 358 per vise die assembly 344, the present invention would reduce machine downtime due to wear of the gripping surfaces 358.

The above specification, examples and data provide a complete description of the manufacture and use of the composition of the invention. Since many embodiments of the invention can be made without departing from the spirit and scope of the invention, the invention resides in the claims hereinafter appended.

1. (canceled)

2. A vise assembly comprising:
a first arm assembly having a first arm member and a first tong head connected to the first arm member;
a second arm assembly pivotally connected to the first arm assembly, the second arm assembly having a second arm member and a second tong head connected to the second arm member;
at least one vise die assembly pivotally mounted on each of the first and second tong heads, the vise die assembly including:
a mounting block having a first face and an oppositely disposed second face; and
a vise die mounted to each of the first and second faces, the vise die including a gripping surface, the gripping surface of the vise die mounted to the first face facing in a direction opposite the gripping surface of the vise die mounted to the second face.

3. The vise assembly of claim 2, wherein the first tong head is pivotally connected to the first arm member.

4. The vise assembly of claim 3, wherein the second tong head is pivotally connected to the second arm member.

5. The vise assembly of claim 2, wherein the first tong head includes at least one pivot stop that limits the range of pivotal motion of the vise die assembly relative to the first tong head.

6. The vise assembly of claim 5, wherein the first tong head includes a pair of pivot stops that cooperatively limit the range of pivotal motion of the vise die assembly relative to the first tong head.

7. The vise assembly of claim 6, wherein the vise die assembly is mounted between the pair of pivot stops.

8. The vise assembly of claim 2, wherein the vise die assembly is mounted to the first tong head by a pivot pin.

9. The vise assembly of claim 2, wherein each of the first and second faces of the vise die assembly defines a groove in which the vise die is disposed.

10. The vise assembly of claim 9, wherein each groove has a dovetail configuration.

11. The vise assembly of claim 9, wherein the grooves of the first and second faces extend the length of the first and second faces.

12. A vise assembly comprising:
a first arm assembly having:
a first arm member;
a first tong head pivotally connected to the first arm member at a first tong pivot;
a first actuator connected to the first arm member;
a second arm assembly pivotally connected to the first arm assembly at a pivot, the second arm assembly having:
a second arm member;
a second tong head pivotally connected to the second arm member at a second tong pivot;
a second actuator connected to the second arm member, wherein the first actuator and the second actuator effectuate the opening and closing of the first and second arm members and the first and second tong heads;
at least one vise die assembly pivotally mounted on each of the first and second tong heads, the vise die assembly including:
a mounting block having a first face and an oppositely disposed second face; and
a vise die mounted to each of the first and second faces, the vise die including a gripping surface, the gripping surface of the vise die mounted to the first face facing in a direction opposite the gripping surface of the vise die mounted to the second face.

13. The vise assembly of claim 12, wherein the first actuator includes a rod end connected to the first arm member and a cylinder end connected to the first tong head and the second actuator includes a rod end connected to the second arm member and a cylinder end connected to the second tong head.

14. The vise assembly of claim 12, wherein the first tong head includes at least one pivot stop that limits the range of pivotal motion of the vise die assembly relative to the first tong head.

15. The vise assembly of claim 14, wherein the first tong head includes a pair of pivot stops that cooperatively limit the range of pivotal motion of the vise die assembly relative to the first tong head.

16. The vise assembly of claim 15, wherein the vise die assembly is mounted between the pair of pivot stops.

17. The vise assembly of claim 12, wherein the vise die assembly is mounted to the first tong head by a pivot pin.

18. The vise assembly of claim 12, wherein each of the first and second faces of the vise die assembly defines a groove in which the vise die is disposed.

19. The vise assembly of claim 18, wherein each groove has a dovetail configuration.

20. The vise assembly of claim 18, wherein the grooves of the first and second faces extend the length of the first and second faces.
